(19) United States
(12) Patent Application Publication
(10) Pub. No.: US 2026/0188100 A1
(43) Pub. Date: Jul. 2, 2026

(54) METHODS AND SYSTEMS FOR PROVIDING CONTEXT-BASED EMERGENCY ALERTS

(71) Applicant: MOTOROLA SOLUTIONS, INC., Chicago, IL (US)

(72) Inventors: Joseph Namm, Plantation, FL (US); David J. Ley, Plantation, FL (US)

(21) Appl. No.: 19/005,831

(22) Filed: Dec. 30, 2024

(51) Int. Cl. G08B 25/00; G08B 7/06; G08B 21/02; G08B 21/18; G08B 25/10; H04W 4/02; H04W 4/021; H04W 4/90

(52) U.S. Cl. CPC G08B 25/008; G08B 7/06; G08B 21/02; G08B 21/182; G08B 25/10; H04W 4/021; H04W 4/023; H04W 4/90

(57) ABSTRACT

A first communication device may include an electronic processor configured to receive an alarm alert transmitted by a second communication device. The alarm alert may include an indication of an alarm mode implemented by the second communication device at a time that the alarm alert was transmitted by the second communication device. In response to determining that the first communication device is within a proximity threshold to the second communication device, the electronic processor controls one or more of its output devices to output a first alarm notification in accordance with the alarm mode of the second communication device. In response to determining that the first communication device is outside of the proximity threshold from the second communication device, the electronic processor controls the one or more output devices to output a second alarm notification in accordance with a current alarm mode of the first communication device.

### BACKGROUND OF THE INVENTION

People performing tasks and/or handling incidents (e.g., public safety officers handling public safety incidents, security officers handling a security incident, etc.) may use communication devices to communicate with each other. These communication devices may include an emergency alert feature to allow a first person to indicate that they themselves and/or another person is in an emergency situation. The emergency alert feature of the first person's communication device may provide an emergency alert to the communication devices of other people (e.g., other people on a task/incident team, other people involved in handling the incident, etc.).

### BRIEF DESCRIPTION OF THE SEVERAL VIEWS OF THE DRAWINGS

In the accompanying figures, similar or the same reference numerals may be repeated to indicate corresponding or analogous elements. These figures, together with the detailed description, below are incorporated in and form part of the specification and serve to further illustrate various embodiments, examples, aspects, and features of concepts that include the claimed subject matter, and to explain various principles and advantages of those embodiments, examples, aspects, and features.

FIG. 1 is a diagram of a communication system according to one example embodiment.

FIG. 2 is a block diagram of a communication device included in the communication system of FIG. 1 according to one example embodiment.

FIG. 3 is a flowchart of a method of providing an alarm output (e.g., an emergency alarm output/notification) on the communication device of FIG. 2 according to one example embodiment.

FIG. 4 is a flowchart of a method of providing an alarm output (e.g., an emergency alarm output/notification) on the communication device of FIG. 2 according to another example embodiment.

FIG. 5A illustrates a use case involving a compromised situation where a silent/covert alarm alert is initiated by one communication device while nearby communication devices are not operating in a silent/covert alarm mode and not operating according to the method of FIG. 3 or 4, according to one example embodiment.

FIG. 5B illustrates another use case involving the compromised situation where a silent/covert alarm alert is initiated by one communication device while nearby communication devices are not operating in a silent/covert alarm mode but are operating according to the method of FIG. 3 or 4, according to one example embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of the examples, aspects, and features presented in this disclosure.

The system, apparatus, and method components have been represented where appropriate by conventional symbols in the drawings, showing only those specific details that are pertinent to understanding of the various embodiments, examples, aspects, and features of the present disclosure so as not to obscure the disclosure with details that will be readily apparent to those of ordinary skill in the art having the benefit of the description herein.

### DETAILED DESCRIPTION OF THE INVENTION

As noted, communication devices may include an emergency alert feature (i.e., an alarm alert feature) to provide an emergency alert to other communication devices. For example, a first communication device may receive a user input to activate the emergency alert feature. In response to activation of the emergency alert feature, the first communication device may transmit (e.g., broadcast) an emergency alert to other communication devices. Some of these other communication devices may be located nearby the first communication device while others of these other communication devices may be located farther away (e.g., remotely located) from the first communication device.

Each communication device may be set to a respective alarm mode/profile that indicates how the respective communication device provides output(s) to a user in response to receiving an emergency alert from another communication device (e.g., the first communication device). Because each communication device may be used in a different situation, the respective alarm modes of communication devices may be different than each other. For example, the alarm mode of each communication device may correspond to the given situation and/or role/task of the communication device and/or its associated user.

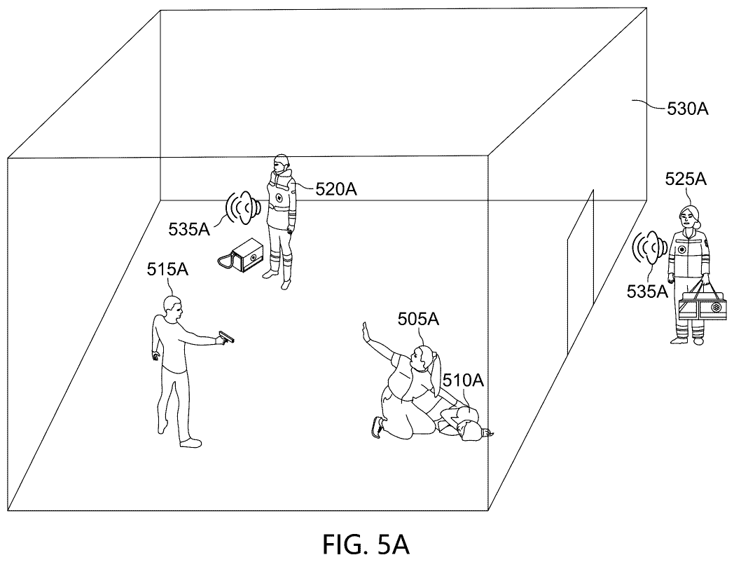

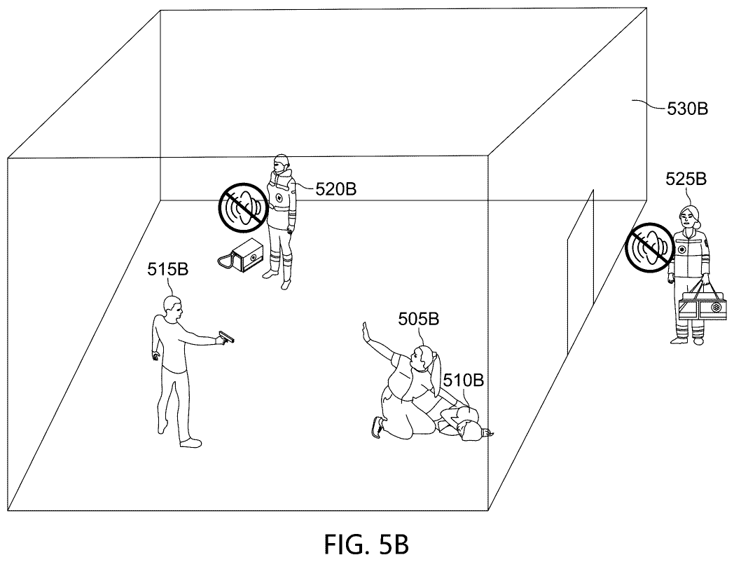

In many instances, the alarm mode of communication devices (e.g., a default alarm mode) is set to a loud, audible alarm to ensure that users notice the alarm and/or to alert others in the area of an emergency. However, an audible alarm is not always desirable. For example, an example use case in FIG. 5A illustrates a compromised situation where a first user 505A (e.g., a paramedic 505A) is handling a public safety incident involving a gunshot victim 510A, and an active shooter 515A approaches the paramedic 505A. In this situation, the paramedic 505A may desire to provide an emergency alert to other public safety officers without the active shooter 515A recognizing that the emergency alert has been provided (e.g., a silent/covert alarm/distress call). Via a user input, the communication device of the paramedic 505A may allow the paramedic 505A to silently/covertly provide the emergency alert to request assistance and/or change alarm modes such that the communication device silently/covertly alerts the paramedic 505A in response to receiving other emergency alerts from other communication devices.

However, loud, audible alarms of communication devices of nearby public safety officers 520A, 525A that receive the emergency notification from the paramedic's communication device may not be set to operate in silent/covert mode. For example, the nearby public safety officers 520A, 525A may be unaware of the compromised situation (e.g., because they are located outside of a room/building 530A in which the compromised situation is occurring but close enough for the active shooter 515A to hear a loud, audible alarm if it sounded—see public safety officer 525A in FIG. 5A) or the nearby public safety officers 520A, 525A may be unable or may forget to adjust their communication device to be in a silent/covert alarm mode. As indicated in FIG. 5A, even though the emergency alert feature of the communication device of the paramedic 505A was activated while the communication device of the paramedic 505A was in a silent/covert alarm mode, the communication devices of other nearby public safety officers 520A, 525A provide a loud, audible alert 535A in response to receiving the emergency alert from the communication device of the paramedic 505A, which may agitate the active shooter 515A.

Accordingly, there is room for a technological improvement with respect to communication devices that include an emergency alert feature. Specifically, there is room to improve the functionality of the emergency alert feature of communication devices receiving an emergency alert to respond/behave in a manner depending on a context of the transmitting communication device and the receiving communication device.

The disclosed methods, devices, and systems provide, among other things, mechanisms and techniques for outputting context-based emergency notifications on communication devices in an attempt to keep users safer in compromised situations. As explained herein, the disclosed methods, devices, and systems include a receiving communication device determining whether it is within a proximity threshold of the transmitting communication device. The proximity determination is then used by the receiving communication device to determine whether to output an emergency notification in accordance with an alarm mode of the transmitting communication device (in response to determining that the receiving communication device is within the proximity threshold of the transmitting communication device) or in accordance with a current alarm mode of the receiving communication device (in response to determining that the receiving communication device is not within the proximity threshold of the transmitting communication device).

The disclosed methods, devices, and systems provide a technological improvement by controlling different communication devices to provide emergency notifications for the same emergency alert in a different manner depending on their location relative to the transmitting communication device that initiated the emergency alert (i.e., the alarm alert). As indicated above, such control of communication devices keeps users in or near compromised situations safer while allowing users farther away from the compromised situation to receive an emergency notification in accordance with preconfigured characteristics/settings of a set alarm mode/profile of their communication device. Additionally, the nearby users in or near the compromised situation may still receive a silent/covert emergency notification as explained herein.

One example provides a first communication device that may include a network interface, and one or more output devices. The first communication device may also include an electronic processor coupled to the network interface and to the one or more output devices. The electronic processor may be configured to receive, via the network interface, an alarm alert transmitted by a second communication device. The alarm alert may include an indication of an alarm mode implemented by the second communication device at a time that the alarm alert was transmitted by the second communication device. The electronic processor also may be configured to determine whether a proximity of the first communication device to the second communication device is within a proximity threshold. The electronic processor also may be configured to in response to determining that the first communication device is within the proximity threshold to the second communication device, control the one or more output devices to output a first alarm notification in accordance with the alarm mode of the second communication device. The electronic processor also may be configured to in response to determining that the first communication device is outside of the proximity threshold from the second communication device, control the one or more output devices to output a second alarm notification in accordance with a current alarm mode of the first communication device.

In addition to any combination of features described above, at least one setting of the alarm mode of the second communication device may be different than the at least one setting of the current alarm mode of the first communication device such that the first alarm notification is different than the second alarm notification.

In addition to any combination of features described above, the at least one setting of the alarm mode of the second communication device that is different than the at least one setting of the current alarm mode of the first communication device includes an audio level at which an alarm notification is output by the first communication device. A first audio level of the alarm mode of the second communication device may be zero such that the first alarm notification is silent. A second audio level of the alarm mode of the first communication device may be non-zero such that the second alarm notification is not silent.

In addition to any combination of features described above, the electronic processor may be configured to temporarily control the one or more output devices in accordance with the alarm mode of the second communication device, when outputting the first alarm notification in response to receiving the alarm alert transmitted by the second communication device, without changing the current alarm mode of the first communication device with respect to additional alarm alerts that are received by the first communication device.

In addition to any combination of features described above, the first alarm notification may be different from the second alarm notification due to the electronic processor outputting the first alarm notification on the first communication device in accordance with the alarm mode of the second communication device by changing an operation of at least one of the one or more output devices that would otherwise occur when outputting the second alarm notification on the first communication device in accordance with the current alarm mode of the first communication device.

In addition to any combination of features described above, the electronic processor may be configured to output the first alarm notification on the first communication device in accordance with the alarm mode of the second communication device by preventing operation of at least one of the one or more output devices that would otherwise occur when outputting the second alarm notification on the first communication device in accordance with the current alarm mode of the first communication device.

In addition to any combination of features described above, the one or more output devices may include at least one of a group consisting of an audio output device, a visual output device, a haptic output device, and combinations thereof.

In addition to any combination of features described above, the electronic processor may be configured to determine the proximity of the first communication device to the second communication device by at least one of a group consisting of: determining whether the alarm alert was received by the network interface via a direct device-to-device communication channel; determining whether the alarm alert was received by the network interface as a short distance beacon; receiving a location of the second communication device and comparing the location of the second communication device to a location of the first communication device; determining whether the location of the first communication device is within a geofence associated with an incident in which the second communication device is being used; and combinations thereof.

In addition to any combination of features described above, the electronic processor may be configured to determine whether the alarm alert was received by the network interface via a direct device-to-device communication channel. The electronic processor also may be configured to determine, in response to determining that the alarm alert was received by the network interface via the direct device-to-device communication channel, that the first communication device is within the proximity threshold to the second communication device. The electronic processor also may be configured to determine, in response to determining that the alarm alert was not received the network interface via the direct device-to-device communication channel, whether the alarm alert was received by the network interface as a short distance beacon. The electronic processor also may be configured to determine, in response to determining that the alarm alert was received by the network interface as a short distance beacon, that the first communication device is within the proximity threshold to the second communication device. The electronic processor also may be configured to compare, in response to determining that the alarm alert was not received by the network interface as a short distance beacon, a location of the second communication device to a location of the first communication device. The electronic processor also may be configured to determine, in response to determining that a distance between the location of the second communication device and the location of the first communication device is less than or equal to a distance threshold, that the first communication device is within the proximity threshold to the second communication device. The electronic processor also may be configured to determine, in response to determining that the distance between the location of the second communication device and the location of the first communication device is greater than the distance threshold, that the first communication device is outside of the proximity threshold from the second communication device.

Another example provides a method of providing an alarm output. The method may include receiving, via a network interface of a first communication device, an alarm alert transmitted by a second communication device. The alarm alert may include an indication of an alarm mode implemented by the second communication device at a time that the alarm alert was transmitted by the second communication device. The method may also include determining, with an electronic processor of the first communication device, whether a proximity of the first communication device to the second communication device is within a proximity threshold. The method may also include in response to determining that the first communication device is within the proximity threshold to the second communication device, controlling, with the electronic processor, one or more output devices of the first communication device to output a first alarm notification in accordance with the alarm mode of the second communication device. The first communication device may be otherwise configured to control the one or more output devices to output a second alarm notification in accordance with a current alarm mode of the first communication device.

In addition to any combination of features described above, at least one setting of the alarm mode of the second communication device may be different than the at least one setting of the current alarm mode of the first communication device such that the first alarm notification is different than the second alarm notification.

In addition to any combination of features described above, the at least one setting of the alarm mode of the second communication device that is different than the at least one setting of the current alarm mode of the first communication device may include an audio level at which an alarm notification is output by the first communication device. A first audio level of the alarm mode of the second communication device may be zero such that the first alarm notification is silent. A second audio level of the alarm mode of the first communication device may be non-zero such that the second alarm notification is not silent.

In addition to any combination of features described above, the method may further include temporarily controlling, with the electronic processor, the one or more output devices in accordance with the alarm mode of the second communication device, when outputting the first alarm notification in response to receiving the alarm alert transmitted by the second communication device, without changing the current alarm mode of the first communication device with respect to additional alarm alerts that are received by the first communication device.

In addition to any combination of features described above, the first alarm notification may be different from the second alarm notification due to the electronic processor outputting the first alarm notification on the first communication device in accordance with the alarm mode of the second communication device by changing an operation of at least one of the one or more output devices that would otherwise occur when outputting the second alarm notification on the first communication device in accordance with the current alarm mode of the first communication device.

In addition to any combination of features described above, outputting the first alarm notification on the first communication device in accordance with the alarm mode of the second communication device may include preventing, with the electronic processor, operation of at least one of the one or more output devices that would otherwise occur when outputting the second alarm notification on the first communication device in accordance with the current alarm mode of the first communication device.

In addition to any combination of features described above, the one or more output devices may include at least one of a group consisting of an audio output device, a visual output device, a haptic output device, and combinations thereof.

In some aspects, the techniques described herein relate to a method, wherein determining the proximity of the first communication device to the second communication device includes at least one of a group consisting of: determining, with the electronic processor, whether the alarm alert was received by the network interface via a direct device-to-device communication channel; determining, with the electronic processor, whether the alarm alert was received by the network interface as a short distance beacon; receiving, with the electronic processor and via the network interface, a location of the second communication device and comparing, with the electronic processor, the location of the second communication device to a location of the first communication device; determining, with the electronic processor, whether the location of the first communication device is within a geofence associated with an incident in which the second communication device is being used; and combinations thereof.

In addition to any combination of features described above, the method may further include determining, with the electronic processor, whether the alarm alert was received by the network interface via a direct device-to-device communication channel. The method may further include determining, with the electronic processor and in response to determining that the alarm alert was received by the network interface via the direct device-to-device communication channel, that the first communication device is within the proximity threshold to the second communication device. The method may further include determining, with the electronic processor and in response to determining that the alarm alert was not received the network interface via the direct device-to-device communication channel, whether the alarm alert was received by the network interface as a short distance beacon. The method may further include determining, with the electronic processor and in response to determining that the alarm alert was received by the network interface as a short distance beacon, that the first communication device is within the proximity threshold to the second communication device. The method may further include comparing, with the electronic processor and in response to determining that the alarm alert was not received by the network interface as a short distance beacon, a location of the second communication device to a location of the first communication device. The method may further include determining, with the electronic processor and in response to determining that a distance between the location of the second communication device and the location of the first communication device is less than or equal to a distance threshold, that the first communication device is within the proximity threshold to the second communication device. The method may further include determining, with the electronic processor and in response to determining that the distance between the location of the second communication device and the location of the first communication device is greater than the distance threshold, that the first communication device is outside of the proximity threshold from the second communication device.

Another example includes a method of providing an alarm output. The method may include transmitting, with a first network interface of a first communication device, an alarm alert to one or more other communication devices. Transmitting the alarm alert may include transmitting an indication of an alarm mode implemented by the first communication device at a time that the alarm alert was transmitted by the first communication device. The method may also include receiving, with a second network interface of a second communication device, the alarm alert. The method may also include determining, with an electronic processor of the second communication device, a proximity of the second communication device to the first communication device. The method may also include in response to determining that the second communication device is within a proximity threshold to the first communication device, outputting, with one or more output devices of the second communication device, an alarm notification in accordance with the alarm mode of the first communication device.

In addition to any combination of features described above, the method may also include receiving, with the second network interface of the second communication device, a second alarm alert from the first communication device or from a third communication device. The second alarm alert may include a second indication of a second alarm mode implemented by the first communication device or the third communication device at a time that the second alarm alert was transmitted by the first communication device or the third communication device. The method may also include determining, with the electronic processor of the second communication device, a second proximity of the second communication device to the first communication device or the third communication device that transmitted the second alarm alert. The method may also include in response to determining that the second communication device is outside of the proximity threshold from the first communication device or the third communication device that transmitted the second alarm alert, outputting, with the one or more output devices of the second communication device, a second alarm notification in accordance with a current alarm mode of the second communication device.

Each of the above-mentioned examples will be discussed in more detail below, starting with example system and device architectures of the system in which the examples may be practiced, followed by an illustration of processing blocks for achieving an improved technical method, device, and system for providing context-based emergency alerts.

Examples are herein described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some aspects, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any example, feature, aspect, or embodiment discussed in this specification can be implemented or combined with any part of any other example, feature, aspect, or embodiment discussed in this specification. For ease of description, some or all of the example systems and devices presented herein are illustrated with a single example of each of its component parts. Some examples may not describe or illustrate all components of the systems or devices. Other example embodiments may include more or fewer of each of the illustrated components, may combine some components, or may include additional or alternative components.

Further advantages and features consistent with this disclosure will be set forth in the following detailed description, with reference to the figures.

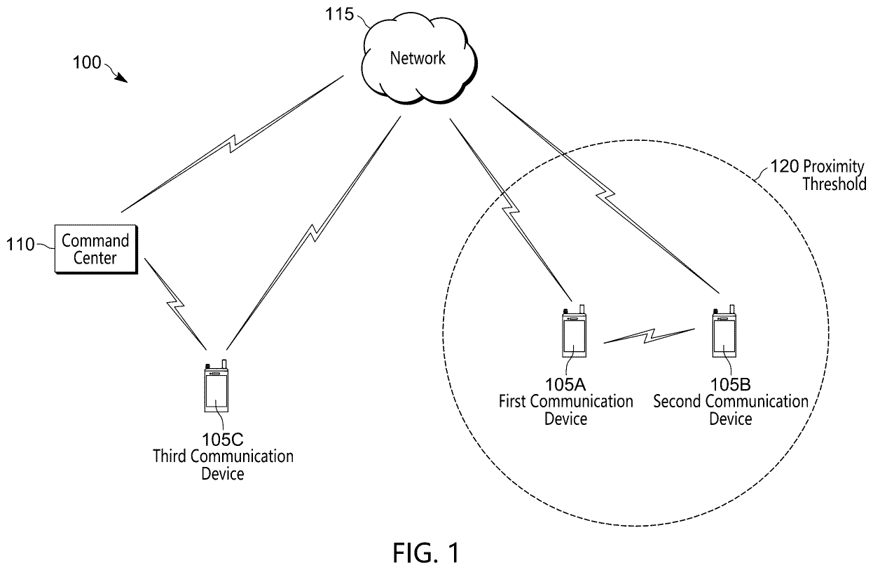

FIG. 1 is a diagram of a communication system 100 according to one example embodiment. In the example illustrated, the communication system 100 includes a first communication device 105A, a second communication device 105B, and a third communication device 105C. The communication devices 105 may be configured to be operated by a user (e.g., a security officer, a public safety officer, managers, supervisors, foremen, crisis response coordinators, and/or the like). Each communication device 105 may be associated with a specific user (e.g., during a work shift or for the lifetime of the communication device 105). While numerous examples/use cases herein refer to public safety officers (e.g., police officers, firefighters, paramedics, and/or the like), the disclosed systems, methods, and devices may be applied in any other situation/context in which it is desirable to provide an emergency alert (i.e., an alarm alert) from one communication device 105 to a plurality of other communication devices 105.

As indicated by the above examples and by FIG. 1, in some instances, the communication device 105 is a handheld communication device, for example, a mobile telephone or other portable communication device, mobile vehicular radio, laptop computer, tablet computer, smart watch or other smart wearable, or may be another user equipment (UE) device configured to communicate with other devices included in the communication system 100. In some embodiments, the communication device 105 is a desktop computer located at a command center 110. When referring to the command center 110, it should be understood that one or more communication devices 105 within the command center 110 provide the communication capabilities for the command center 110. In some instances, a communication device 105 may include ancillary devices communicatively coupled together. For example, the communication device 105 may include a handheld communication device and a smart watch that are both associated with a single user.

As illustrated in FIG. 1, the communication devices 105 in the communication system 100 are configured to communicate with each other via wired and/or wireless communication (for example, by sending and receiving radio signals directly to and from each other when within wireless communication range of each other and/or via a base station of a communication network 115). In an example embodiment, the communication network 115 that allows for bidirectional communication between devices in the communication system 100 is a 5G/LTE communication network. However, other communication networks may also be used. The communication network 115 may include wireless and wired portions. All or parts of the communication network 115 may be implemented using various existing or future-developed specifications or protocols. In some embodiments, the communication network 115 is implemented using a direct-mode, conventional, or trunked land mobile radio (LMR) standard or protocol, for example, a Digital Mobile Radio (DMR) standard defined by the European Telecommunications Standards Institute (ETSI), a Project 25 (P25 ) standard defined by the Association of Public Safety Communications Officials International (APCO), a Terrestrial Trunked Radio (TETRA) standard defined by the European Telecommunications Standards Institute (ETSI), or other LMR radio protocols or standards. In some embodiments, the communication network 115 implements the Long Term Evolution (LTE) (including LTE-Advanced or LTE-Advanced Pro compliant with, for example, the 3GPP TS 36 specification series), or the 5G (including a network architecture compliant with, for example, the 3GPP TS 23 specification series and a new radio (NR) air interface compliant with the 3GPP TS 38 specification series) standard, among other possibilities, and over which multimedia broadcast multicast services (MBMS), single site point-to-multipoint (SC-PTM) services, or Mission Critical Push-to-talk (MCPTT) services may be provided, or over which an open mobile alliance (OMA) push to talk (PTT) over cellular (OMA-PoC), a voice over IP (VoIP), or a PTT over IP (PoIP) application may be implemented. The communication network 115 may also include future developed networks. In some embodiments, the communication network 115 may also include a combination of the networks mentioned.

In some embodiments, the communication devices 105 may additionally or alternatively be configured to communicate directly with each other using a communication channel or connection that is outside of the communication network 115. In some embodiments, the communication devices 105 may additionally or alternatively communicate with each other via wired or wireless connections, for example, over a local network that may be similar to the communication network 115 described immediately above. In some embodiments, the local network may be a local area network (LAN). In some embodiments, the communication devices 105 may additionally or alternatively communicate directly with each other when they are within a predetermined distance from each other using short-range communication mechanisms such as Bluetooth®, WiFi, direct radio-to-radio LMR radio frequency (RF) communication links, and/or the like.

FIG. 1 also indicates a proximity threshold 120 to the first communication device 105A. As explained in greater detail herein, when other communication devices 105 (e.g., the second communication device 105B) are within the proximity threshold 120, these other communication devices 105 are close enough to the first communication device 105A such that the emergency notification operation/behavior of these communication devices 105 may be altered to be the same as the first communication device 105A when the first communication device 105A provides an emergency alert (i.e., an alarm alert). On the other hand, when other communication devices 105 (e.g., the third communication device 105C) are outside of the proximity threshold 120, these other communication devices 105 are far enough away from the first communication device 105A such that the emergency notification operation/behavior of these communication devices 105 may not be altered when the first communication device 105A provides an emergency alert. As described in greater detail herein, the proximity threshold 120 may be determined/estimated in one or more of various different manners. In some instances, the proximity threshold 120 is large enough to ensure that a loud, audible alarm output/notification from a communication device 105 that is outside of the proximity threshold 120 will not be heard by a user of the first communication device 105A and/or by people nearby the first communication device 105A. On the other hand, an audible alarm output/notification from a communication device 105 that is within the proximity threshold 120 will may be heard by the user of the first communication device 105A and/or by people nearby the first communication device 105A.

FIG. 1 illustrates only one example embodiment of the communication system 100. In other embodiments, the system 100 may include more or fewer components and may perform functions that are not explicitly described herein. For example, the communication system 100 may include additional or fewer communication devices 105 and command centers 110 (i.e., command center communication devices). As another example, more or fewer communication devices 105 may be located within or outside of the proximity threshold to the first communication device 105A. For example, the third communication device 105C may move to be within the proximity threshold 120 of the first communication device 105A and/or may be able to bi-directionally communicate with the first communication device 105A when it is within direct communication range of the first communication device 105A.

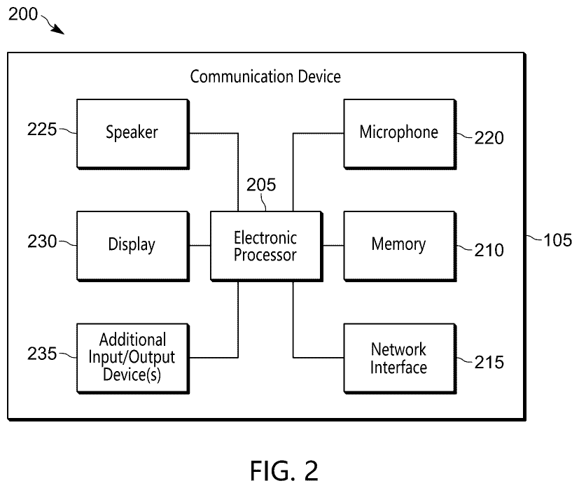

FIG. 2 is a block diagram 200 of a communication device 105 according to one example. In the example illustrated, the communication device 105 includes an electronic processor 205 (for example, a microprocessor or other electronic device). The electronic processor 205 includes input and output interfaces (not shown) and is electrically coupled to a memory 210, a network interface 215, a microphone 220, a speaker 225, a display 230, and one or more optional additional input/output devices 235.

The memory 210 may include read only memory (ROM), random access memory (RAM), other non-transitory computer-readable media, or a combination thereof. The electronic processor 205 is configured to receive instructions and data from the memory 210 and execute, among other things, the instructions. In particular, the electronic processor 205 executes instructions stored in the memory 210 to perform the methods described herein.

The network interface 215 sends and receives data to and from other devices in the system 100 (e.g., other communication devices 105, etc.) over the network 115 and/or via a direct-mode wireless link. In some examples, the network interface 215 includes one or more transceivers and one or more antennas for wirelessly communicating with the network 115 and/or the other communication devices 105 directly. Alternatively or in addition, the network interface 215 may include a connector or port for receiving a wired connection to the network 115, such as an Ethernet cable. The electronic processor 205 may transmit and receive data (for example, a video call, an audio call, an image, a text message, an emergency alert message and associated data, sensor input data gathered by one or more sensors of the communication device 105, and the like) over the network 115 and/or directly through the first network interface 215 to/from other communication devices 105. For example, the electronic processor 205 receives electrical signals representing sound from the microphone 220 and may communicate information relating to the electrical signals over the network 115 or directly to another communication device 105 through the first network interface 215 to other communication devices 105, to allow users to communicate with each other. Similarly, the electronic processor 205 may output data received from the network 115 or directly from another communication device 105 via the first network interface 215 through the speaker 225, the display 230, or a combination thereof.

In some instances, the electronic processor 205 may communicate an emergency alert (i.e., an alarm alert) and a current alarm mode of the communication device 105 initiating the emergency alert over the network 115 or directly to another communication device 105 through the network interface 215, for example, for receipt by one or more other communication devices 105 in the system 100.

The display 230 displays images, video, text, and/or data to the user. The display 230 may be a liquid crystal display (LCD) screen or an organic light emitting display (OLED) display screen. In some examples, a touch sensitive input interface may be incorporated into the display 230 as well, allowing the user to interact with content provided to the display 230. In some examples, the display 230 includes a projector or future-developed display technologies. In some examples, the speaker 225 and the display 230 are referred to as output devices that output data to a user of the communication device 105. In some examples, the microphone 220, a computer mouse, and/or a keyboard or a touch-sensitive display are referred to as input devices that receive input from a user of the communication device 105.

The communication device 105 may also include optional additional input/output devices 235 that may include additional visual output devices (e.g., one or more light-emitting diodes (LEDs), etc.), additional audio output devices (e.g., a buzzer, a horn, etc.), and/or a haptic output device (e.g., one or more vibration motors, etc.) to output a haptic notification. In some instances, the additional input/output devices 235 additionally or alternatively include one or more user input buttons configured to be actuated to initiate an emergency alert. Actuation of an emergency alert button or actuation of a combination of user inputs (e.g., simultaneous actuation of multiple certain user input buttons) may cause the electronic processor 205 to initiate an emergency alert as described herein. In some instances, an emergency alert may be automatically initiated (e.g., without active user input) by the electronic processor 205 in response to detection of an emergency situation/event. For example, the electronic processor 205 may include one or more sensors that detect that the user of the communication device 105 has fallen and has not moved, has a dangerous/concerning/unexpected change in a monitored biometric value, etc. In response thereto, the electronic processor 205 may automatically initiate the emergency alert. In some instances, the emergency alert may be initiated remotely for the communication device 105. For example, a communication device 105 at the command center 110 may provide an instruction to the communication device 105 to thereby remotely initiate the emergency alert at the communication device 105 (e.g., if a dispatcher realizes that the user of the communication device 105 may be in an emergency situation).

In some examples, the communication device 105 includes fewer or additional components in configurations different from that illustrated in FIG. 2. For example, the communication device 105 may additionally include a push-to-talk button and/or a camera. As another example, the communication device 105 may include one or more sensors that monitor a context of a user of the communication device 105 and may be referred to as context sensors. For example, the one or more sensors are biometric sensors that monitor one or more of a heart rate of the user, a body temperature of the user, a blood pressure of the user, and other biometric characteristics of the user. The one or more sensors may include an accelerometer or other sensor configured to detect whether a user has fallen. In some examples, the communication device 105 includes a location component/device (for example, a global positioning system receiver) configured to determine the geographic coordinates of the location of the communication device 105. In some examples, the communication device 105 does not include the additional input/output device(s) 235 and may rely on the microphone 220, the speaker 225, and the display 230 as the only input/output devices.

In some examples, the electronic processor 205 may include a plurality of electronic processors that are distributed within the communication device 105 and that together each perform one or more functions. For example, the electronic processor 205 may include one or more electronic processors that receive data from the network interface 215 and one or more same and/or different electronic processors that receive user inputs from input devices and control output devices to provide outputs to the user. Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed. In some examples, the communication device 105 performs functionality other than the functionality described below.

In some instances, the memory 210 may store multiple selectable alarm modes (i.e., alarm profiles) with different characteristics/settings for controlling one or more output devices of the communication device 105 in response to receiving an alarm alert from another communication device 105. For example, a first alarm mode may be a default/regular alarm mode that causes a communication device 105 receiving an emergency alert from another communication device 105 to provide a loud, audible alarm as an emergency notification (i.e., an alarm notification), for example, with the speaker 225 and/or a buzzer, horn, and/or the like. As another example, a second alarm mode may be a silent/covert alarm mode that does not provide any audible alarm but instead provides a subtle haptic notification using a haptic output device, for example, that causes brief and minor vibrations. The second alarm mode may additionally or alternatively provide a visual output using a visual output device such as a light emitting diode (LED). The second alarm mode may alternatively refrain from providing any outputs from any output devices. As indicated by the two examples immediately above, the second alarm mode is more subtle and less noticeable to others surrounding the user of a communication device 105 than the first alarm mode.

Additional and/or alternative alarm modes may also be saved in the memory 210 and/or communicated to the communication device 105 for implementation. For example, each alarm mode may be specifically configured as desired (e.g., by a manager or leader of a public safety agency) to provide different combinations of outputs and/or refrain from providing different combinations of outputs. In some instances, a current alarm mode of a communication device 105 is set or selected by the communication device 105 using channel selection. For example, usage of a first channel by a communication device 105 may set the alarm mode of the communication device 105 to the first alarm mode while usage of a second channel by the communication device 105 may set the alarm mode of the communication device 105 to the second alarm mode. In some instances, the current alarm mode of a communication device 105 is set based on a role/function of the user of the communication device 105. For example, a default alarm mode for a communication device 105 of a firefighter may be the first alarm mode to allow other firefighters to locate an injured or trapped firefighter by following a loud, audible alarm output by the communication device 105 of the injured or trapped firefighter. As another example, a default alarm mode for other public safety officers such as a paramedic may be the second alarm mode since a loud, audible alarm may not be desirable when the paramedic is in close proximity to a victim being treated because a loud, audible alarm may disturb the paramedic and/or the victim.

As described herein, in some instances, the electronic processor 205 may be configured to receive a user input to initiate a silent/covert emergency alarm alert. For example, the communication device 105 may receive a user input to set the current alarm mode of the communication device 105 (i.e., an emergency alert transmitting communication device 105) as the second alarm mode (i.e., the silent/covert alarm mode) and may receive a user input to initiate an emergency alarm alert.

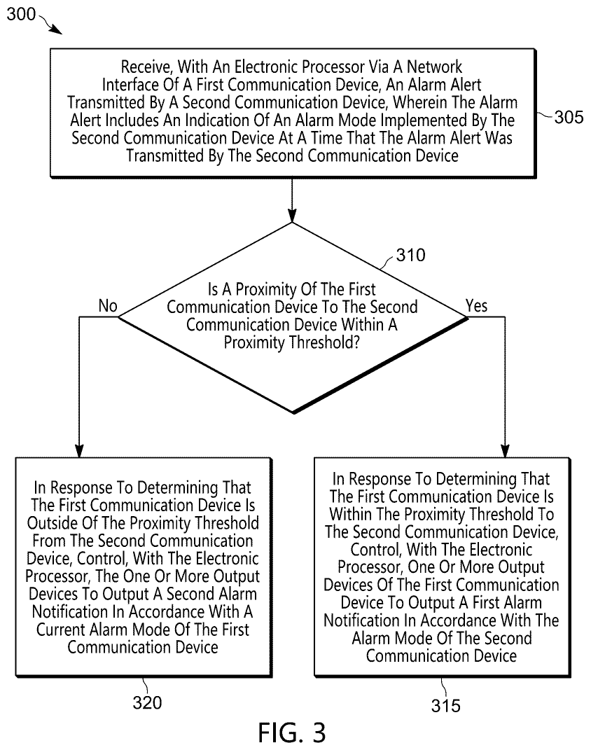

FIG. 3 is a flowchart of a method 300 of providing an alarm output (e.g., an emergency alarm output/notification) on a communication device 105 according to one example embodiment. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure.

In some embodiments, the method 300 is performed by a communication device 105 that has received an emergency alert (i.e., an alarm alert) from another communication device 105. Specifically, the method 300 may be performed by the electronic processor 205 of the communication device 105 that received the emergency alert from another communication device 105. As explained previously herein, the electronic processor 205 may include one or more distributed electronic processors.

An instance of the method 300 begins at block 305, where the electronic processor 205 of a first communication device 105 (i.e., an emergency alert receiving communication device 105B, 105C) receives, via the network interface 215, an alarm alert transmitted by a second communication device (i.e., an emergency alert transmitting communication device 105A). With reference to FIG. 1 as an example, the second communication device 105 of some examples herein may correspond to communication device 105A despite the label in FIG. 1, and the first communication device 105 of some examples herein may include communication devices 105B and/or 105C despite the labels in FIG. 1. Generally speaking, all communication devices 105 of the system 100 are configured to be an emergency alert transmitting communication device 105 in some instances and is configured to be an emergency alert receiving communication device in other instances. The alarm alert from the second communication device 105A may include an indication of an alarm mode implemented by the second communication device 105A at a time that the alarm alert was transmitted by the second communication device 105A. For example, the alarm alert transmitted by the second communication device 105 may indicate that a user of the second communication device 105 is in an emergency situation and may indicate that a current alarm mode of the second communication device 105 is set in the first alarm mode, the second alarm mode, or a different alarm mode. In some instances, the alarm alert transmitted by the second communication device 105 may also include a location of the second communication device 105 (e.g., as determined by a location component/device of the second communication device 105, for example, in response to the emergency alert being initiated at the second communication device 105).

At block 310, the electronic processor 205 determines whether a proximity of the first communication device 105 to the second communication device 105 is within a proximity threshold 120 from the second communication device 105 (i.e., emergency alert transmitting communication device 105A). As indicated in FIG. 3, the electronic processor 205 determines whether the proximity of the first communication device 105 to the second communication device 105 is within the proximity threshold 120 in response to receiving the alarm alert at block 305.

In some instances, the electronic processor 205 is configured to determine the proximity of the first communication device 105 to the second communication device 105 by determining whether the alarm alert was received by the network interface 215 via a direct device-to-device communication channel. When the alarm alert is received via a direct device-to-device communication channel, the electronic processor 205 may determine that the first communication device 105 is within direct radio to radio LMR RF transmission range of the second communication device 105. In response thereto, the electronic processor 205 may determine that the first communication device 105 is within the proximity threshold 120 of the second communication device 105 without precisely calculating the locations of each communication device 105, which may save time and processing power.

In some instances, the electronic processor 205 is configured to determine the proximity of the first communication device 105 to the second communication device 105 by determining whether the alarm alert was received by the network interface 215 as a short distance beacon (e.g., an out-of-band low power beacon such as a Bluetooth® low energy (BLE) beacon). When the alarm alert is received as a short distance beacon, the electronic processor 205 may determine that the first communication device 105 is within the proximity threshold 120 of the second communication device 105 without precisely calculating the locations of each communication device 105, which may save time and processing power similar to determining that the first communication device 105 is within direct radio to radio LMR RF transmission range of the second communication device 105 as described above. However, the direct radio to radio LMR RF transmission range may be smaller than the transmission range of a short distance beacon. Therefore, a certainty with which the proximity determination is made may be more accurate by determining that the alarm alert was received using direct radio to radio LMR RF transmission than by determining that the alarm alert was received as a short distance beacon.

In some instances, the electronic processor 205 is configured to determine the proximity of the first communication device 105 to the second communication device 105 by receiving a location of the second communication device 105 (e.g., included in the alarm alert as indicated above) and comparing the location of the second communication device 105 to a location of the first communication device 105 (e.g., as determined by its own location component/device).

In some instances, the electronic processor 205 is configured to determine the proximity of the first communication device 105 to the second communication device 105 by determining whether the location of the first communication device 105 is within a geofence associated with an incident (e.g., a public safety incident) in which the second communication device 105 is being used. For example, a geofence may established around a fire, vehicle accident, robbery, and/or other incident, and the emergency alarm alert transmitting communication device 105 may be assigned to be used during the incident. Geofence coordinates associated with the incident may be included in the alarm alert received by the emergency alarm alert receiving communication device 105. Additionally or alternatively, the emergency alarm alert receiving communication device 105 may request and receive the geofence coordinates of the incident associated with the emergency alarm alert transmitting communication device 105 from another communication device 105 (e.g., a communication device 105 located at the command center 110). The electronic processor 205 of the emergency alarm alert receiving communication device 105 may then compare its own location to the geofence coordinates to determine whether the emergency alarm alert receiving communication device 105 is within the proximity threshold 120 of the emergency alarm alert transmitting communication device 105.

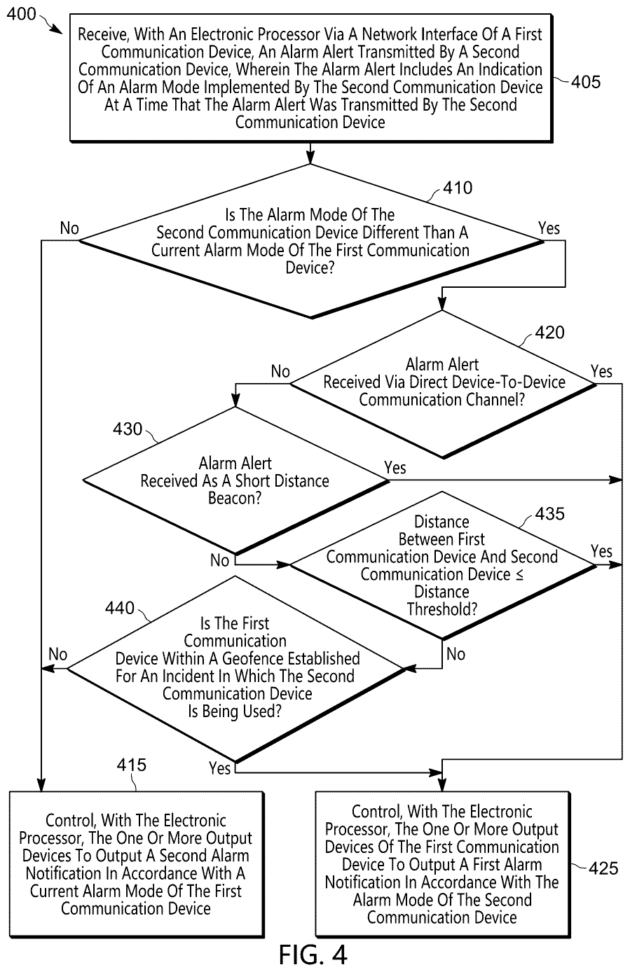

In some instances, any one or a combination of the example manners of determining whether the proximity of the first communication device 105 to the second communication device 105 is within the proximity threshold 120 may be used by the electronic processor 205. For example, the electronic processor 205 may determine that the first communication device 105 is within the proximity threshold 120 in response to determining that any one or any combination of the above-described proximity determination manners indicates that the second communication device 105 is within the proximity threshold 120. Alternatively, the electronic processor 205 may determine that the first communication device 105 is within the proximity threshold 120 using just one of the above-described proximity determination manners without using the other manners. As yet another alternative, the electronic processor 205 may determine that the first communication device 105 is within the proximity threshold 120 in a tiered manner as described with respect to FIG. 4 below.

As indicated by the potential use of different proximity detection manners, the proximity threshold 120 (e.g., the exact distance from the emergency alarm alert transmitting communication device 105A) is not necessarily identical for each proximity detection manner. Nevertheless, the above-noted manners of determining the proximity of the first communication device 105 to the second communication device 105 provide a reasonably reliable indicator of whether a loud, audible alarm from the emergency alarm alert receiving communication device 105 will be heard by the user of the emergency alarm alert transmitting communication device 105 and/or people nearby the emergency alarm alert transmitting communication device 105. In other words, and as explained previously herein, the proximity threshold 120 is large enough to ensure that a loud, audible emergency alarm from a communication device 105 that is outside of the proximity threshold 120 will not be heard by a user of the emergency alarm alert transmitting communication device 105A and/or people nearby the emergency alarm alert transmitting communication device 105A.

At block 315, in response to determining that the first communication device 105 is within the proximity threshold 120 to the second communication device 105 (and in response to receiving the alarm alert from the second communication device 105), the electronic processor 205 controls one or more output devices of the first communication device 105 (i.e., the emergency alarm alert receiving communication device 105B) to output a first alarm notification in accordance with the alarm mode of the second communication device 105 (i.e., the emergency alarm alert transmitting communication device 105A). On the other hand, at block 320, in response to determining that the first communication device 105 is outside of the proximity threshold 120 from the second communication device 105 (and in response to receiving the alarm alert from the second communication device 105), the electronic processor 205 controls the one or more output devices of the first communication device 105 (i.e., the emergency alarm alert receiving communication device 105C) to output a second alarm notification in accordance with a current alarm mode of the first communication device 105 (i.e., the emergency alarm alert receiving communication device 105C).

As indicated by blocks 315 and 320, the electronic processor 205 may control the communication device 105B, 105C differently depending on whether the communication device 105B, 105C is within the proximity threshold 120 of the emergency alarm alert transmitting communication device 105A (e.g., whether people nearby the communication device 105A are within hearing range for an audible alarm of the communication device 105B, 105C). In some instances, at least one setting of the alarm mode of the second communication device 105A is different than the at least one setting of the current alarm mode of the first communication device 105B such that the first alarm notification (of block 315) is different than the second alarm notification (of block 320).

In some instances, the at least one setting of the alarm mode of the second communication device 105A that is different than the at least one setting of the current alarm mode of the first communication device 105B includes an audio level at which an alarm notification is output by the first communication device 105B. For example, a first audio level of the alarm mode of the second communication device 105A is zero such that the first alarm notification is silent, and a second audio level of the alarm mode of the first communication device 105B is non-zero such that the second alarm notification is not silent. In some instances, the first alarm notification is different from the second alarm notification due to the electronic processor 205 outputting the first alarm notification on the first communication device 105B in accordance with the alarm mode of the second communication device 105A by changing an operation of at least one of the one or more output devices that would otherwise occur when outputting the second alarm notification on the first communication device 105B in accordance with the current alarm mode of the first communication device 105B. For example, the electronic processor 205 may reduce/limit operation of an output device (e.g., less vibration of a haptic output device, less flashing or less bright flashing of a visual output device such as a light or display 230, etc.). As another example, the electronic processor 205 may output the first alarm notification on the first communication device 105B in accordance with the alarm mode of the second communication device 105A by preventing operation of at least one of the one or more output devices that would otherwise occur when outputting the second alarm notification on the first communication device 105B in accordance with the current alarm mode of the first communication device 105. For example, the electronic processor 205 may prevent all audio output devices from providing an output. In some instances, the electronic processor 205 outputs the first alarm notification on the first communication device 105B in accordance with the alarm mode of the second communication device 105A by additionally or alternatively adding operation of an output device (e.g., a haptic output device) that would not have otherwise occurred when outputting the second alarm notification on the first communication device 105B in accordance with the current alarm mode of the first communication device 105B.

In the examples above, the electronic processor 205 of the first communication device 105B (i.e., the emergency alarm alert receiving communication device 105B) is configured to temporarily control its one or more output devices in accordance with the alarm mode of the second communication device 105A (i.e., the emergency alarm alert transmitting communication device 105A) when outputting the first alarm notification in response to receiving the alarm alert transmitted by the second communication device 105A. Accordingly, communication devices 105 nearby the emergency alarm alert transmitting communication device 105A (e.g., operated by the paramedic 505B in FIG. 5B) also refrain from providing audible outputs in response to receiving the alarm alert from the communication device 105A. For example, as shown in FIG. 5B, the communication devices 105 associated with the public safety officers 520B, 525B that are nearby the communication device 105 of the paramedic 505B (i.e., within the proximity threshold 120) refrain from providing an audible alarm notification in response to receiving an alarm alert from the paramedic's communication device 105 that is in a silent/covert alarm mode. Preventing such audible alarm notifications that would otherwise occur based on the alarm modes of nearby communication devices 105 of the public safety officers 520B, 525B may prevent a dangerous/compromised situation from escalating by preventing agitation of the active shooter 515B that may occur if audible alarm notifications are provided by nearby communication devices 105 of the public safety officers 520B, 525B.

In the examples above, the electronic processor 205 of the first communication device 105B (i.e., the emergency alarm alert receiving communication device 105B) is configured to temporarily control its one or more output devices in accordance with the alarm mode of the second communication device 105A (i.e., the emergency alarm alert transmitting communication device 105A) when outputting the first alarm notification in response to receiving the alarm alert transmitted by the second communication device 105A. However, the electronic processor 205 is configured to make this control change in a temporary manner (i.e., only applicable to output(s) associated with the specific/current alarm alert) without changing the current alarm mode of the first communication device 105B with respect to additional alarm alerts that are received by the first communication device 105B.

In other words, the first communication device 105B outputs the alarm alert from the second communication device 105A in accordance with the alarm mode of the second communication device 105A because the first communication device 105B is within the proximity threshold 120 from the second communication device 105A. However, the electronic processor 205 is configured to maintain its own alarm mode/alarm mode settings and re-perform the method 300 for any additional alarm alerts that are received from the second communication device 105A and/or other communication devices 105. By maintaining its own alarm mode/alarm mode settings, the first communication device 105B continues to operate according to its own alarm mode unless the first communication device 105B is within the proximity threshold 120 to another communication device 105 (e.g., communication device 105A) that transmitted an alarm alert and that did so in an alarm mode different than the first communication device 105B (e.g., with one or more different alarm mode settings), particularly a silent/covert alarm mode that is different than the alarm mode of the first communication device 105B.

As one example of repeating the method 300 each time an alarm alert is received, in some instances, the electronic processor 205 of the first communication device 105B, 105C (i.e., the emergency alarm alert receiving communication device 105C) receives a second alarm alert (e.g., after receiving the first alarm alert and outputting a corresponding alarm notification) from the second communication device 105A or from a third communication device 105. The second alarm alert may include a second indication of a second alarm mode implemented by the second communication device 105A or the third communication device 105 at a time that the second alarm alert was transmitted by the second communication device 105A or the third communication device 105. The electronic processor 205 may determine a second proximity of the first communication device 105B, 105C to the second communication device 105A or the third communication device 105 that transmitted the second alarm alert. In response to determining that the first communication device 105B, 105C is outside of the proximity threshold 120 from the second 105A communication device or the third communication device 105 that transmitted the second alarm alert (e.g., due to movement of one or both of the communication devices 105A and 105B away from each other since the first alarm alert was received), the electronic processor 205 may output an alarm notification in accordance with a current alarm mode of the first communication device 105B, 105C.

In other words and as indicated by block 320, when the first communication device 105C (i.e., the emergency alarm alert receiving communication device 105C) is outside of the proximity threshold 120 from the second communication device 105A (i.e., the emergency alarm alert transmitting communication device 105A), the electronic processor 205 of the first communication device 105C controls one or more output devices to output the alarm notification (e.g., the second alarm notification) in accordance with the current alarm/settings of the first communication device 105C because the first communication device 105C is determined to be far enough away from the second communication device 105A such that the alarm notification by the first communication device 105C should not be heard, seen, and/or otherwise recognized by people nearby the second communication device 105A.

FIG. 4 is a flowchart of a method 400 of providing an alarm output (e.g., an emergency alarm output/notification) on a communication device 105 according to one example embodiment. While a particular order of processing steps, message receptions, and/or message transmissions is indicated in FIG. 4 as an example, timing and ordering of such steps, receptions, and transmissions may vary where appropriate without negating the purpose and advantages of the examples set forth in detail throughout the remainder of this disclosure.

In some embodiments, the method 400 is performed by a communication device 105 that has received an emergency alert (i.e., an alarm alert) from another communication device 105. Specifically, the method 400 may be performed by the electronic processor 205 of the communication device 105 that received the emergency alert from another communication device 105. As explained previously herein, the electronic processor 205 may include one or more distributed electronic processors. The method 400 is similar to the method 300 described previously herein except for the more specific determinations described below. Accordingly, the remainder of the details described with respect to the method 300 that are not inconsistent with the description of the method 400 still apply to the method 400.

An instance of the method 400 begins at block 405, where the electronic processor 205 of the communication device 105 (i.e., an emergency alert receiving communication device 105) receives, via the network interface 215, an alarm alert transmitted by a second communication device (i.e., an emergency alert transmitting communication device 105). Block 405 is similar to block 305 of FIG. 3, and the same description applies.

At block 410, the electronic processor 205 determines whether the alarm mode of the second communication device 105 is different than a current alarm mode of the first communication device 105 (e.g., determines whether any alarm mode settings regarding control of one or more output devices are different). Additionally or alternatively, at block 410, the electronic processor 205 determines whether the alarm mode of the second communication device 105 is a silent/covert alarm mode.

In response to the alarm mode of the second communication device 105 being the same as the alarm mode of the first communication device 105, at block 415, the electronic processor 205 controls one or more output devices to output an alarm notification in accordance with the current alarm mode of the first communication device 105 as described previously herein. On the other hand, in response to the alarm mode of the second communication device 105 being different than the alarm mode of the first communication device 105, the electronic processor 205 may determine whether the alarm mode of the second communication device 105 is a silent/covert alarm mode. Such a determination may be made to prevent the first communication device 105 that is already in a silent/covert alarm mode from outputting an audible alarm in accordance with an audible alarm mode of the emergency alarm alert transmitting communication device 105. In other words, if the alarm mode of the second communication device 105 is less covert than the alarm mode of the first communication device 105, the electronic processor 205 may proceed to block 415 since the more covert alarm mode of the first communication device 105 will not unduly disturb/alert the user of the second communication device 105 or people nearby the second communication device 105. In some instances, the electronic processor 205 may immediately determine whether the alarm mode of the second communication device 105 is a silent/covert alarm mode without determining whether the alarm mode of the second communication device 105 is different than the current alarm mode of the first communication device 105 (for example, such a determination may replace block 410 of FIG. 4).

In some instances, in response to determining that the alarm mode of the second communication device 105 is not a silent/covert alarm mode (i.e., an alarm mode that does not require discretion from nearby communication devices 105), the electronic processor 205 may proceed to block 415 and control one or more output devices to output an alarm notification in accordance with the current alarm mode of the first communication device 105 as described previously herein. On the other hand, in response to determining that the alarm mode of the second communication device 105 is a silent/covert alarm mode (i.e., an alarm mode that does require discretion from nearby communication devices 105), the electronic processor 205 may determine whether a proximity of the first communication device 105 to the second communication device 105 is within a proximity threshold 120. As another alternative that does not involve determination of whether the alarm mode of the second communication device 105 is a silent/covert alarm mode, in some instances, in response to determining that the alarm mode of the second communication device 105 is different than the current alarm mode of the first communication device 105 (at block 410), the electronic processor 205 may determine whether the proximity of the first communication device 105 to the second communication device 105 is within the proximity threshold 120.

Blocks 420, 430, 435, and 440 of FIG. 4 illustrate a tiered manner in which the electronic processor 205 may determine that the first communication device 105 is within the proximity threshold 120. This tiered manner of proximity determination may determine proximity in an efficient manner that saves time and power/processing resources of the first communication device 105 since later blocks/calculations do not need to be performed unless earlier blocks do not indicate that the first communication device 105 is within the proximity threshold 120 from the second communication device 105.

At block 420, the electronic processor 205 determines whether the alarm alert was received by the network interface 215 via a direct device-to-device communication channel. As explained previously herein, when the alarm alert is received via a direct device-to-device communication channel, the electronic processor 205 may determine that the first communication device 105 is within direct radio to radio LMR RF transmission range of the second communication device 105. In response there to, the electronic processor 205 may determine that the first communication device 105 is within the proximity threshold 120 of the second communication device 105 without precisely calculating the locations of each communication device 105, which may save time and processing power of the first communication device 105. In other words, blocks 430, 435, and 440 of the method 400 are skipped, and at block 425, the electronic processor 205 controls one or more output devices of the first communication device 105 to output an alarm notification in accordance with the alarm mode of the second communication device 105 as explained previously herein.

On the other hand, when the electronic processor 205 determines that the alarm alert was not received by the network interface 215 via the direct device-to-device communication channel, at block 430, the electronic processor 205 determines whether the alarm alert was received by the network interface 215 as a short distance beacon. As explained previously herein, when the alarm alert is received as a short distance beacon, the electronic processor 205 may determine that the first communication device 105 is within the proximity threshold 120 of the second communication device 105 without precisely calculating the locations of each communication device 105, which may save time and processing power similar to determining that the first communication device 105 is within direct radio to radio LMR RF transmission range of the second communication device 105 as described above. However, the direct radio to radio LMR RF transmission range may be smaller than the transmission range of a short distance beacon. Therefore, a certainty with which the proximity determination is made may be more accurate by determining that the alarm alert was received using direct radio to radio LMR RF transmission than by determining that the alarm alert was received as a short distance beacon. In response to determining that the alarm alert is received as a short distance beacon, the method 400 may proceed to block 425 and skip blocks 435 and 440.

On the other hand, when the electronic processor 205 determines that the alarm alert was not received as a short distance beacon, at block 435, the electronic processor 205 compares a location of the second communication device 105 to a location of the first communication device 105. The electronic processor 205 may then determine whether a distance between the location of the second communication device and the location of the first communication device is less than or equal to a distance threshold. In response to determining that the distance between the location of the second communication device and the location of the first communication device is less than or equal to the distance threshold, the electronic processor 205 may determine that the first communication device 105 is within the proximity threshold 120 to the second communication device 105, and may proceed to block 425 and skip block 440.

On the other hand, in response to determining that the distance between the location of the second communication device and the location of the first communication device is greater than the distance threshold, at block 440, the electronic processor 205 may determine whether the first communication device is within a geofence established for an incident in which the second communication device 105 is being used, as described previously herein. In response to determining that the first communication device 105 is within the geofence, the electronic processor 205 may determine that the first communication device 105 is within the proximity threshold 120 to the second communication device 105, and may proceed to block 425. On the other hand, in response to determining that the first communication device 105 is outside of the geofence, the electronic processor 205 may determine that the first communication device 105 is outside of the proximity threshold 120 from the second communication device 105, and may proceed to block 415.

While FIG. 4 illustrates four tiers of proximity determinations with less complicated and/or more accurate proximity determinations being performed before more complicated and/or less accurate proximity determinations, in other instances, the number of tiers of proximity determinations may be greater or less than four. For example, any one of the blocks 420, 430, 435, or 440 may be removed from FIG. 4 in some instances. Additional or alternative proximity determinations may be used as additional or alternative tiers of proximity determinations in some instances. In some instances, the type of proximity determinations and the number of proximity determination tiers may be user-configurable by a manager/leader of a public safety agency. Additionally, parameters associated with the proximity threshold 120 (e.g., the distance threshold) may be user-configurable by a manager/leader of a public safety agency. Furthermore, alarm mode settings, default alarm modes, alarm mode assignments for different officers with different roles, etc. may be user-configurable by a manager/leader of a public safety agency.

As should be apparent from this detailed description above, the operations and functions of the electronic processor(s) are sufficiently complex as to require their implementation on a computer system, and cannot be performed, as a practical matter, in the human mind. Electronic processors such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot output different types of alarm notifications on output devices of a communication device depending on whether the communication device is within a proximity threshold of another communication device, among other features and functions set forth herein).

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments, examples, aspects, and features may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more of the embodiments, examples, aspects, and features presented herein can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A first communication device comprising:
a network interface;
one or more output devices; and
an electronic processor coupled to the network interface and to the one or more output devices, the electronic processor configured to:
receive, via the network interface, an alarm alert transmitted by a second communication device, wherein the alarm alert includes an indication of an alarm mode implemented by the second communication device at a time that the alarm alert was transmitted by the second communication device;
determine whether a proximity of the first communication device to the second communication device is within a proximity threshold;
in response to determining that the first communication device is within the proximity threshold to the second communication device, control the one or more output devices to output a first alarm notification in accordance with the alarm mode of the second communication device; and
in response to determining that the first communication device is outside of the proximity threshold from the second communication device, control the one or more output devices to output a second alarm notification in accordance with a current alarm mode of the first communication device.

2. The first communication device of claim 1, wherein at least one setting of the alarm mode of the second communication device is different than the at least one setting of the current alarm mode of the first communication device such that the first alarm notification is different than the second alarm notification.

3. The first communication device of claim 2, wherein the at least one setting of the alarm mode of the second communication device that is different than the at least one setting of the current alarm mode of the first communication device includes an audio level at which an alarm notification is output by the first communication device;
wherein a first audio level of the alarm mode of the second communication device is zero such that the first alarm notification is silent;
wherein a second audio level of the alarm mode of the first communication device is non-zero such that the second alarm notification is not silent.

4. The first communication device of claim 2, wherein the electronic processor is configured to temporarily control the one or more output devices in accordance with the alarm mode of the second communication device, when outputting the first alarm notification in response to receiving the alarm alert transmitted by the second communication device, without changing the current alarm mode of the first communication device with respect to additional alarm alerts that are received by the first communication device.

5. The first communication device of claim 2, wherein the first alarm notification is different from the second alarm notification due to the electronic processor outputting the first alarm notification on the first communication device in accordance with the alarm mode of the second communication device by changing an operation of at least one of the one or more output devices that would otherwise occur when outputting the second alarm notification on the first communication device in accordance with the current alarm mode of the first communication device.

6. The first communication device of claim 5, wherein the electronic processor is configured to output the first alarm notification on the first communication device in accordance with the alarm mode of the second communication device by preventing operation of at least one of the one or more output devices that would otherwise occur when outputting the second alarm notification on the first communication device in accordance with the current alarm mode of the first communication device.

7. The first communication device of claim 1, wherein the one or more output devices includes at least one of a group consisting of an audio output device, a visual output device, a haptic output device, and combinations thereof.

8. The first communication device of claim 1, wherein the electronic processor is configured to determine the proximity of the first communication device to the second communication device by at least one of a group consisting of:
determining whether the alarm alert was received by the network interface via a direct device-to-device communication channel;
determining whether the alarm alert was received by the network interface as a short distance beacon;
receiving a location of the second communication device and comparing the location of the second communication device to a location of the first communication device;
determining whether the location of the first communication device is within a geofence associated with an incident in which the second communication device is being used; and
combinations thereof.

9. The first communication device of claim 1, wherein the electronic processor is configured to:
determine whether the alarm alert was received by the network interface via a direct device-to-device communication channel;
determine, in response to determining that the alarm alert was received by the network interface via the direct device-to-device communication channel, that the first communication device is within the proximity threshold to the second communication device;
determine, in response to determining that the alarm alert was not received the network interface via the direct device-to-device communication channel, whether the alarm alert was received by the network interface as a short distance beacon;
determine, in response to determining that the alarm alert was received by the network interface as a short distance beacon, that the first communication device is within the proximity threshold to the second communication device;
compare, in response to determining that the alarm alert was not received by the network interface as a short distance beacon, a location of the second communication device to a location of the first communication device;
determine, in response to determining that a distance between the location of the second communication device and the location of the first communication device is less than or equal to a distance threshold, that the first communication device is within the proximity threshold to the second communication device; and
determine, in response to determining that the distance between the location of the second communication device and the location of the first communication device is greater than the distance threshold, that the first communication device is outside of the proximity threshold from the second communication device.

10. A method of providing an alarm output, the method comprising:
receiving, via a network interface of a first communication device, an alarm alert transmitted by a second communication device, wherein the alarm alert includes an indication of an alarm mode implemented by the second communication device at a time that the alarm alert was transmitted by the second communication device;
determining, with an electronic processor of the first communication device, whether a proximity of the first communication device to the second communication device is within a proximity threshold; and
in response to determining that the first communication device is within the proximity threshold to the second communication device, controlling, with the electronic processor, one or more output devices of the first communication device to output a first alarm notification in accordance with the alarm mode of the second communication device, wherein the first communication device is otherwise configured to control the one or more output devices to output a second alarm notification in accordance with a current alarm mode of the first communication device.

11. The method of claim 10, wherein at least one setting of the alarm mode of the second communication device is different than the at least one setting of the current alarm mode of the first communication device such that the first alarm notification is different than the second alarm notification.

12. The method of claim 11, wherein the at least one setting of the alarm mode of the second communication device that is different than the at least one setting of the current alarm mode of the first communication device includes an audio level at which an alarm notification is output by the first communication device;
wherein a first audio level of the alarm mode of the second communication device is zero such that the first alarm notification is silent;
wherein a second audio level of the alarm mode of the first communication device is non-zero such that the second alarm notification is not silent.

13. The method of claim 11, further comprising temporarily controlling, with the electronic processor, the one or more output devices in accordance with the alarm mode of the second communication device, when outputting the first alarm notification in response to receiving the alarm alert transmitted by the second communication device, without changing the current alarm mode of the first communication device with respect to additional alarm alerts that are received by the first communication device.

14. The method of claim 11, wherein the first alarm notification is different from the second alarm notification due to the electronic processor outputting the first alarm notification on the first communication device in accordance with the alarm mode of the second communication device by changing an operation of at least one of the one or more output devices that would otherwise occur when outputting the second alarm notification on the first communication device in accordance with the current alarm mode of the first communication device.

15. The method of claim 14, wherein outputting the first alarm notification on the first communication device in accordance with the alarm mode of the second communication device includes preventing, with the electronic processor, operation of at least one of the one or more output devices that would otherwise occur when outputting the second alarm notification on the first communication device in accordance with the current alarm mode of the first communication device.

16. The method of claim 10, wherein the one or more output devices includes at least one of a group consisting of an audio output device, a visual output device, a haptic output device, and combinations thereof.

17. The method of claim 10, wherein determining the proximity of the first communication device to the second communication device includes at least one of a group consisting of:
determining, with the electronic processor, whether the alarm alert was received by the network interface via a direct device-to-device communication channel;
determining, with the electronic processor, whether the alarm alert was received by the network interface as a short distance beacon;
receiving, with the electronic processor and via the network interface, a location of the second communication device and comparing, with the electronic processor, the location of the second communication device to a location of the first communication device;
determining, with the electronic processor, whether the location of the first communication device is within a geofence associated with an incident in which the second communication device is being used; and
combinations thereof.

18. The method of claim 10, further comprising:
determining, with the electronic processor, whether the alarm alert was received by the network interface via a direct device-to-device communication channel;
determining, with the electronic processor and in response to determining that the alarm alert was received by the network interface via the direct device-to-device communication channel, that the first communication device is within the proximity threshold to the second communication device;
determining, with the electronic processor and in response to determining that the alarm alert was not received the network interface via the direct device-to-device communication channel, whether the alarm alert was received by the network interface as a short distance beacon;
determining, with the electronic processor and in response to determining that the alarm alert was received by the network interface as a short distance beacon, that the first communication device is within the proximity threshold to the second communication device;
comparing, with the electronic processor and in response to determining that the alarm alert was not received by the network interface as a short distance beacon, a location of the second communication device to a location of the first communication device;
determining, with the electronic processor and in response to determining that a distance between the location of the second communication device and the location of the first communication device is less than or equal to a distance threshold, that the first communication device is within the proximity threshold to the second communication device; and
determining, with the electronic processor and in response to determining that the distance between the location of the second communication device and the location of the first communication device is greater than the distance threshold, that the first communication device is outside of the proximity threshold from the second communication device.

19. A method of providing an alarm output, the method comprising:
transmitting, with a first network interface of a first communication device, an alarm alert to one or more other communication devices, wherein transmitting the alarm alert includes transmitting an indication of an alarm mode implemented by the first communication device at a time that the alarm alert was transmitted by the first communication device;
receiving, with a second network interface of a second communication device, the alarm alert;
determining, with an electronic processor of the second communication device, a proximity of the second communication device to the first communication device; and
in response to determining that the second communication device is within a proximity threshold to the first communication device, outputting, with one or more output devices of the second communication device, an alarm notification in accordance with the alarm mode of the first communication device.

20. The method of claim 19, further comprising:
receiving, with the second network interface of the second communication device, a second alarm alert from the first communication device or from a third communication device, wherein the second alarm alert includes a second indication of a second alarm mode implemented by the first communication device or the third communication device at a time that the second alarm alert was transmitted by the first communication device or the third communication device;
determining, with the electronic processor of the second communication device, a second proximity of the second communication device to the first communication device or the third communication device that transmitted the second alarm alert; and
in response to determining that the second communication device is outside of the proximity threshold from the first communication device or the third communication device that transmitted the second alarm alert, outputting, with the one or more output devices of the second communication device, a second alarm notification in accordance with a current alarm mode of the second communication device.
